(19) United States
(12) Patent Application Publication
(10) Pub. No.: US 2016/0013892 A1
(43) Pub. Date: Jan. 14, 2016

(54) COMMUNICATION APPARATUS, RECEPTION APPARATUS, AND TRANSMISSION APPARATUS

(71) Applicant: Hidetoshi SUZUKI, Yokohama-shi, Kanagawa (JP)

(72) Inventor: Hidetoshi SUZUKI, Kanagawa (JP)

(21) Appl. No.: 14/768,397

(22) PCT Filed: Mar. 25, 2013
(86) PCT No.: PCT/JP2013/058593

§ 371 Date: Aug. 17, 2015

(51) Int. Cl. H04L 1/16; H04L 1/18

(52) U.S. Cl. CPC H04L 1/1621; H04L 1/18

(57) ABSTRACT

A transmission apparatus (1) transmits data, and a reception apparatus (2) receives the data. The reception apparatus (2) includes a data reception unit (6) receiving the data, and a reception state notification transmission unit (10) periodically transmitting a reception state notification including a range of sequence numbers of the received data and sequence numbers of data which have not been received within the range. The transmission apparatus (1) includes a data transmission unit (5) transmitting the data, a reception state notification reception unit (11) receiving the reception state notification, and a retransmission determining unit (12) making the data transmission unit (5) retransmit data specified in the reception state notification as unreceived data.

### TECHNICAL FIELD

The present invention relates to a communication apparatus, a reception apparatus, and a transmission apparatus which can reduce network loads.

### BACKGROUND ART

When a transmission error is detected in the data received by a reception apparatus in a communication apparatus, an automatic repeat request (ARQ), which requests retransmission of the data, is issued to a transmission apparatus. In the conventional ARQ, retransmission is performed unless an acknowledgement (ACK) response (a response notifying normal data reception) is sent from the reception apparatus. Accordingly, when troubles occur in a network and/or apparatuses, retransmission occurs repeatedly, resulting in a vicious circle of putting a further load on the network. Under these circumstances, communication apparatuses that increase the probability of normal reception of retransmission data have been presented (see Patent Literature 1 for example).

### CITATION LIST

### Patent Literature

Patent Literature 1: Japanese Patent Laid-Open No. 2003-174435

### SUMMARY OF INVENTION

### Technical Problem

However, there is a problem that when an ACK response is lost on a network, the transmission apparatus performs data retransmission although the reception apparatus has received the transmitted data. This retransmission request puts a further load on the network.

The present invention has been made to solve the above-described problems, and an object thereof is to provide a communication apparatus, a reception apparatus, and a transmission apparatus which can reduce network loads.

### Means for Solving the Problems

A communication apparatus according to the present invention includes: a transmission apparatus transmitting data; and a reception apparatus receiving the data, wherein the reception apparatus includes a data reception unit receiving the data, and a reception state notification transmission unit periodically transmitting a reception state notification including a range of sequence numbers of the received data and sequence numbers of data which have not been received within the range, and the transmission apparatus includes a data transmission unit transmitting the data, a reception state notification reception unit receiving the reception state notification, and a retransmission determining unit making the data transmission unit retransmit data specified in the reception state notification as unreceived data.

### Advantageous Effects of Invention

The present invention makes it possible to reduce the load of the network more as compared with the case of the conventional technology at the occurrence of network or apparatus errors.

### BRIEF DESCRIPTION OF THE DRAWINGS

FIG. 1 is a block diagram illustrating a communication apparatus according to an embodiment of the present invention.

FIG. 2 illustrates a sequence example of the communication apparatus according to the embodiment of the present invention.

FIG. 3 illustrates a method for calculating network delay time.

### DESCRIPTION OF EMBODIMENTS

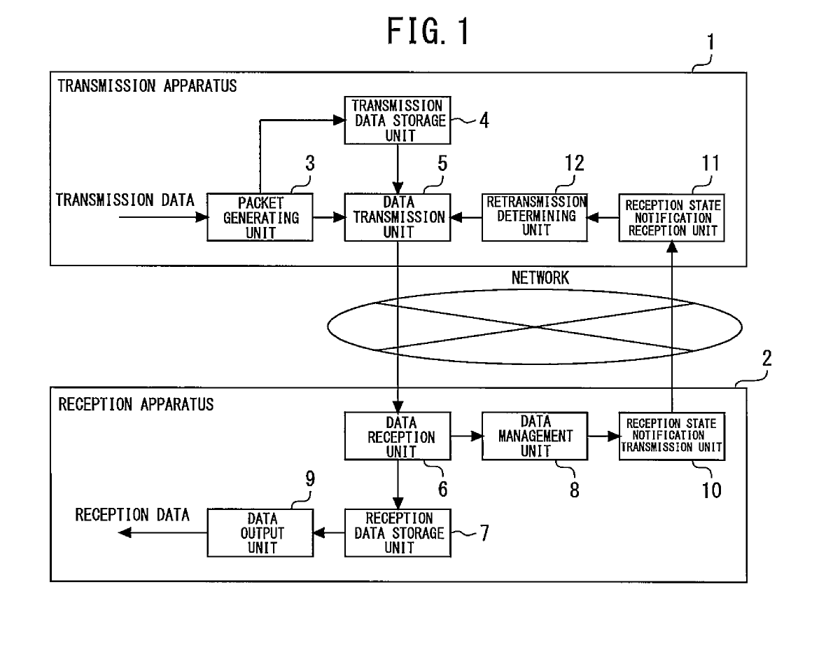

FIG. 1 is a block diagram illustrating a communication apparatus according to an embodiment of the present invention. A transmission apparatus 1 transmits data and a reception apparatus 2 receives the data through a network. In the transmission apparatus 1, a packet generating unit 3 converts the data into packet data. A transmission data storage unit 4 stores the packet data, and a data transmission unit 5 transmits the packet data to the network.

In the reception apparatus 2, when a data reception unit 6 receives data from the network, the received data is stored in a reception data storage unit 7, and the information on reception is stored in a data management unit 8. The data stored in the reception data storage unit 7 is output through a data output unit 9 after the lapse of a fixed period of time. The data management unit 8 monitors a reception state. A reception state notification transmission unit 10 periodically transmits a reception state notification in response to an instruction from the data management unit 8.

The reception state notification includes a range of sequence numbers of received data packets (first packet number and end packet number), the number of data packets (the number of loss packets) which have not been received within the range, and sequence numbers (loss packet numbers) of the lost data packets. The first number represents the sequence number of a data packet which has been received and confirmed to be sequential. The end number represents the sequence number of a latest received data packet.

In the transmission apparatus 1, a reception state notification reception unit 11 receives a reception state notification transmitted from the reception apparatus 2. A retransmission determining unit 12 analyzes the reception state notification. When retransmission is determined as a result of the analysis, the retransmission determining unit 12 reads from the transmission data storage unit 4 a data packet specified in the reception state notification as unreceived data packet. The retransmission determining unit 12 then makes the data transmission unit 5 retransmit the read data packet.

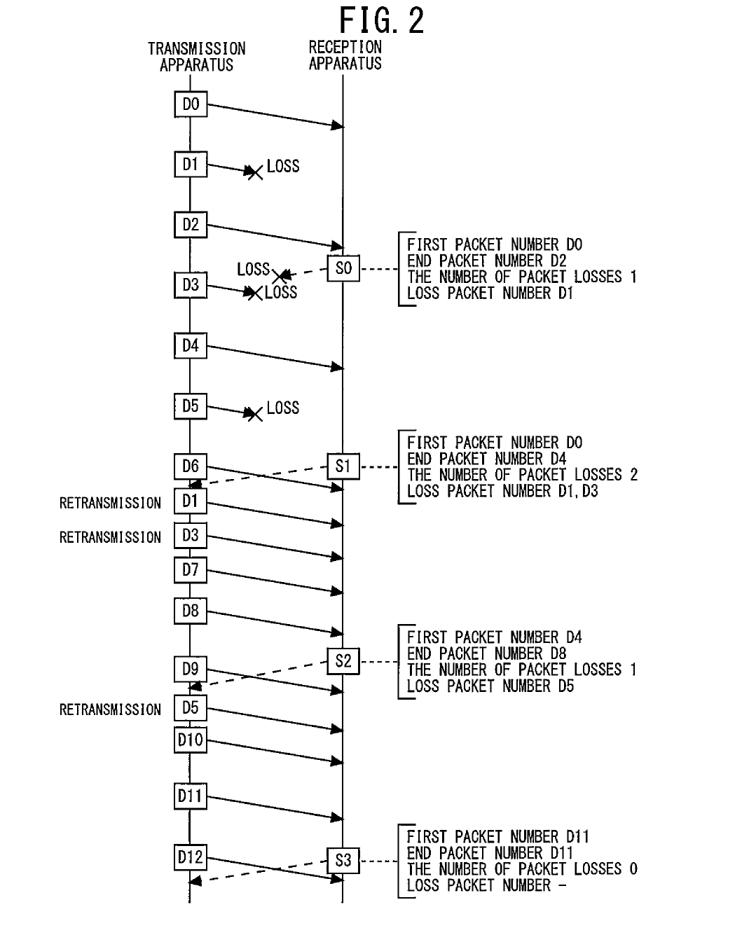

FIG. 2 illustrates a sequence example of the communication apparatus according to the embodiment of the present invention. The transmission apparatus 1 transmits data packet in order. The reception apparatus 2 periodically transmits the reception state notification. Here, it is assumed that data packets D1, D3, D5 and a reception state notification S1 are lost on the network.

The reception state notification S0, which includes the first packet number D0, the end packet number D2, the number of loss packets 1, and the loss packet number D1, is output from the reception apparatus 2, but the reception state notification S0 is lost. Therefore, at this moment of time, the data packet DI is not yet retransmitted. Then, a reception state notification S1, which includes the first packet number DO, the end packet number D4, the number of loss packets 2, and the loss packet numbers D1 and D3, is output from the reception apparatus 2. When the reception state notification S1 reaches the transmission apparatus 1, the data packet D1 and D3 are retransmitted. Similarly, when a reception state notification S2 reaches the transmission apparatus 1, a data packet D5 is retransmitted.

In this way, even when the reception state notification S0 is lost on the network, the data packet D1 is retransmitted in response to the next reception state notification S1. This prevents a problem of waiting for an undelivered ACK response till a time-out occurs as in the case of the conventional ARQ.

As described in the foregoing, in the present embodiment, the reception apparatus 2 periodically transmits the reception state notification instead of returning an ACK response. Upon reception of the reception state notification, the transmission apparatus 1 retransmits the data packet of a sequence number that the reception apparatus 2 has failed to receive. In this way, the transmission apparatus 1 retransmits the data only when the reception state notification is received, so that useless retransmission can be prevented. As a result, at the occurrence of network or apparatus errors, the load of the network can be reduced more as compared with the case of the conventional technology. Even when one reception state notification is lost on the network, the lost notification can be retransmitted as a next reception state notification, since the reception state notification is periodically transmitted.

The reception state notification further includes a latest data reception lapse time that represents elapsed time from reception of the latest data packet, in addition to the range of the sequence numbers of the received data packet, and the sequence number/numbers unreceived in this range. When the retransmission determining unit 12 of the transmission apparatus 1 determines, based on the reception state notification, that the amount of packet loss is too large to be recovered by retransmission, or when the network is interrupted for a long time, the retransmission determining unit 12 suppresses data retransmission or lowers a data transfer rate.

Specifically, the retransmission determining unit 12 determines the amount of packet loss based on the number of losses and the loss number/numbers. When a ratio of the number of unreceived data packet to the number of transmitted data packet exceeds a predetermined value, the retransmission determining unit 12 suppresses data retransmission. When the reception state notification is not delivered for more than a predetermined time, or when the latest data reception lapse time in the reception state notification exceeds the predetermined time, the retransmission determining unit 12 determines that the network is interrupted, and suppresses retransmission of the data packet transmitted during that predetermined time.

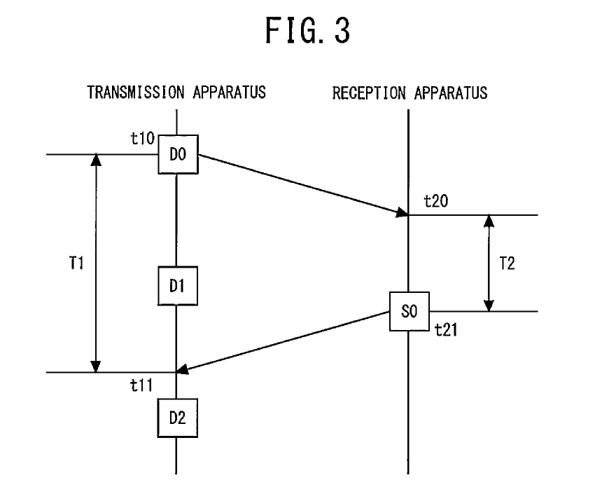

FIG. 3 illustrates a method for calculating network delay time. The transmission apparatus 1 records a data transmission time t10 for all the packets. The reception apparatus 2 records a latest data receipt time t20 and a latest data sequence number. Based on the time t21 at which the reception state notification is transmitted, the latest data reception lapse time T2 (=t21−t20) is calculated.

The transmission apparatus 1 records a time t11 at which the reception state notification is received, and calculates the elapsed time from transmission T1 (=t11-t10), based on the latest sequence number of data packet added to the reception state notification. The network delay time is calculated by subtracting the latest data reception lapse time T2 from the lapsed time from transmission T1. The network delay time is used to determine the timing of trying retransmission repeatedly. Since the reception state notification is transmitted on a periodical basis, the reception apparatus may transmit a next reception state notification, which notifies loss of a data packet, before the data packet retransmitted by the transmission apparatus reached to the reception apparatus. In order to prevent this passing-each-other, a retransmission process is performed in response to the reception of the reception state notification that notifies loss of data, only when a fixed period of time (network delay time+margin) is elapsed from a previous retransmission process performed by the transmission apparatus.

### DESCRIPTION OF SYMBOLS

1 transmission apparatus, 2 reception apparatus, 5 data transmission unit, 6 data reception unit, 10 reception state notification transmission unit, 11 reception state notification reception unit, 12 retransmission determining unit

1. A communication apparatus comprising:
a transmission apparatus transmitting data; and
a reception apparatus receiving the data,
wherein the reception apparatus includes a data reception unit receiving the data, and a reception state notification transmission unit periodically transmitting a reception state notification including a range of sequence numbers of the received data and sequence numbers of data which have not been received within the range, and
the transmission apparatus includes a data transmission unit transmitting the data, a reception state notification reception unit receiving the reception state notification, and a retransmission determining unit making the data transmission unit retransmit data specified in the reception state notification as unreceived data.

2. The communication apparatus of claim 1, wherein the reception state notification further includes a latest data reception lapse time that represents elapsed time from reception of the latest data, and
when a ratio of the number of unreceived data to the number of the transmitted data exceeds a predetermined value, when the reception state notification is not delivered for more than a predetermined time, or when the latest data reception lapse time in the reception state notification exceeds a predetermined time, the transmission apparatus suppresses data retransmission or lowers a data transfer rate.

3. A reception apparatus comprising:
a data reception unit receiving data; and
a reception state notification transmission unit periodically transmitting a reception state notification including a range of sequence numbers of the received data and sequence numbers of data which have not been received within the range.

4. The reception apparatus of claim 3, wherein the reception state notification further includes a latest data reception lapse time that represents elapsed time from reception of the latest data.

5. A transmission apparatus comprising:
a data transmission unit transmitting data;
a reception state notification reception unit receiving a reception state notification including a range of sequence numbers of the data received by a reception apparatus and sequence numbers of data which have not been received within the range; and
a retransmission determining unit making the data transmission unit retransmit data specified in the reception state notification as unreceived data.

6. The transmission apparatus of claim 5, wherein the reception state notification further includes a latest data reception lapse time that represents elapsed time from reception of the latest data, and
when a ratio of the number of unreceived data to the number of the transmitted data exceeds a predetermined value, when the reception state notification is not delivered for more than a predetermined time, or when the latest data reception lapse time in the reception state notification exceeds a predetermined time, the transmission apparatus suppresses data retransmission or lowers a data transfer rate.
